(19) United States
(12) Patent Application Publication
(10) Pub. No.: US 2021/0346974 A1
(43) Pub. Date: Nov. 11, 2021

(54) ENGINE-DRIVEN WELDING MACHINE

(71) Applicant: YAMABIKO CORPORATION, Tokyo (JP)

(72) Inventors: Tadashi MARUOKA, Hiroshima (JP); Takashi NISHIMOTO, Hiroshima (JP); Takafumi FUROKAWA, Hiroshima (JP)

(73) Assignee: YAMABIKO CORPORATION, Tokyo (JP)

(21) Appl. No.: 16/474,783

(22) PCT Filed: May 23, 2019
(86) PCT No.: PCT/JP2019/020484

§ 371 Date: Jun. 28, 2019

(30) Foreign Application Priority Data
Jun. 28, 2018 (JP) 2018-122957

(51) Int. Cl. B23K 9/10; B23K 9/095; F02B 63/04

(52) U.S. Cl. CPC B23K 9/1068; F02B 63/042; B23K 9/0956

(57) ABSTRACT

Disclosed herein is an engine-driven welding machine 1 including: a current selector 52 via which a user sets a current for each of DC power supplies, and which outputs a setting signal based on the current set by user; an output switcher 71; and a controller 4. The output switcher 71 has the function of switching between a first output mode in which outputs of the plurality of DC power supplies 2, 3 are collectively outputted from a predetermined welding output terminal 23, and a second output mode in which outputs of the DC power supplies 2, 3 are individually outputted from the welding output terminals 23, 33. The controller 4 automatically switches between the first and second output modes in accordance with the setting signal received from the current selector 52.

### TECHNICAL FIELD

The present invention relates to an engine-driven welding machine which outputs electric power generated by a generator driven by an engine.

### BACKGROUND ART

An engine-driven welding machine which can be used, in a switchable manner, by a single user or two users has been known.

For example, Patent Document 1 discloses an engine-driven welding machine capable of switching between a two-user operation mode in which two sets of welding output terminals individually output welding currents, and a single-user operation mode in which the two sets of welding output terminals are connected in parallel to output a welding current.

### CITATION LIST

### Patent Documents

[Patent Document 1] Japanese Unexamined Patent Publication No. 2009-195929

### SUMMARY OF THE INVENTION

### Technical Problem

According to the known techniques, the switching between the single-user mode and the two-user mode is performed via a manual switch, involving the following problems. First, a selector switch needs to be manipulated every time a large current region for the single-user mode and a small current region for the two-user mode are alternately used. In addition, according to the known techniques, as shown in FIG. 3 of Patent Document 1, a current regulator is configured to set, at an identical setting position, different current values, namely, a current value for the single-user mode and a current value for the two-user mode. Therefore, it is necessary to regulate the current value with the current regulator every time the switching is performed between the connection for the single-user mode and the connection for the two-user mode via the selector switch.

In view of the foregoing, it is therefore an object of the present invention to provide an engine-driven welding machine which is automatically switchable between a first output mode in which a small number of people can use a large current and a second output mode in which a large number of people can use a small current, in accordance with a current value set at a current selector.

### Solution to the Problem

An engine-driven welding machine according to a first aspect of the present invention has a plurality of DC power supplies, and a plurality of welding output terminals respectively corresponding to the DC power supplies. The engine-driven welding machine includes: a current selector via which a user sets a current for each of the DC power supplies, and which outputs a setting signal based on the current set by the user; an output switcher which performs switching between a first output mode in which outputs of the DC power supplies are collectively outputted from a first output terminal which is a predetermined welding output terminal of the welding output terminals, and a second output mode in which outputs of the DC power supplies are each outputted individually from an associated one of the welding output terminals; and a controller which controls, upon receiving the setting signal from the current selector, the output switcher in accordance with the setting signal, so that the output switcher automatically switches to the first output mode when a value of the set current is equal to or greater than a predetermined current value, or to the second output mode when the value of the set current is less than the predetermined current value.

According to this aspect, the controller automatically switches the output mode (between the first output mode and the second output mode) in accordance with the current set via the current selector. This requires no special operation by the user (e.g., an operation using a switch according to Patent Document 1). In addition, unlike the technique disclosed in Patent Document 1, there is no need to regulate the current value via the current regulator (corresponding to the current selector) every time the switching between the connection for single-user mode and the connection for two-user mode is performed via the selector switch.

The engine-driven welding machine may further include a current measurer which measures an output current outputted from at least one of the plurality of welding output terminals, wherein the controller controls the output switcher when it is determined that no output current is flowing.

Here, “when it is determined that no output current is flowing” is, for example, when a current measured by the current measurer is not flowing substantially. That is, this includes a situation where a weak current is flowing as the output current, and the current measurer detects the weak current. For example, for the determination that no output current is flowing, a predetermined threshold value may be provided based on the product specification or the like, so that determination that no output current is flowing can be made when the measured current falls below the threshold value.

In this manner, the output switcher is operated when the controller determines that no output current is flowing. This can avoid a failure which may be caused by stress applied to the output switcher through the switching between the output modes.

The controller may allow the output switcher to switch from the second output mode to the first output mode after stopping the output of the DC power supply, the output additionally supplying an output current to the first output terminal.

This can reduce the stress applied to the output switcher at the time of the switching of the output mode.

The engine-driven welding machine may further include a current measurer which measures an output current outputted from at least the predetermined welding output terminal of the plurality of welding output terminals. In a situation where the engine-driven welding machine is in the first output mode, the controller maintains the first output mode when a current is flowing through the current measurer.

This makes it possible to avoid frequent operation of a switching relay due to drastic increase or decrease in the set current value.

The engine-driven welding machine may further include a mode selector switch via which the user selects any one of a first output fixing mode in which the engine-driven welding machine is fixed to the first output mode, a second output fixing mode in which the engine-driven welding machine is fixed to the second output mode, or an automatic switching mode. The controller automatically switches the output switcher when the automatic switching mode is selected via the mode selector switch.

This increases the variety of operation of the engine-driven welding machine, and improves the convenience of the user.

The engine-driven welding machine may further include a display which displays a value of each of the output currents of the plurality of welding output terminals. When switching to the first output mode, the controller causes the display corresponding to the other welding output terminals than the predetermined welding output terminal to be in a non-display state or to display zero.

When switching to the second output mode, the controller may cause the display corresponding to all of the welding output terminals to be in a display state.

According to these aspects, the user can be clearly informed of the welding output terminal through which the output current is outputted, and the welding output terminal through which no output current is outputted.

### Advantages of the Invention

According to the present invention, the output modes can be automatically switched in accordance with an output current set via the current selector. This can save time and labor of the user, and can improve the convenience.

### BRIEF DESCRIPTION OF THE DRAWINGS

FIG. 1 is a schematic diagram illustrating a configuration of an engine-driven welding machine according to an embodiment.

FIG. 2A is a flowchart illustrating an example of the operation of the engine-driven welding machine.

FIG. 2B is a flowchart illustrating an example of the operation of the engine-driven welding machine.

FIG. 2C is a flowchart illustrating an example of the operation of the engine-driven welding machine.

FIG. 3A is a view illustrating an example of setting for a manipulation unit and an example of display on a display unit.

FIG. 3B is a view illustrating an example of setting for the manipulation unit and an example of display on the display unit.

FIG. 3C is a view illustrating an example of setting for the manipulation unit and an example of display on the display unit.

FIG. 3D is a view illustrating an example of setting for the manipulation unit and an example of display on the display unit.

FIG. 3E is a view illustrating an example of setting for the manipulation unit and an example of display on the display unit.

FIG. 3F is a view illustrating an example of setting for the manipulation unit and an example of display on the display unit.

FIG. 4 is a schematic diagram illustrating the configuration of another example of the engine-driven welding machine.

### DESCRIPTION OF EMBODIMENTS

Embodiments of the present invention will be described in detail with reference to the drawings. The following embodiments are merely exemplary ones in nature, and are not intended to limit the scope, applications, or use of the invention.

An engine-driven welding machine of this embodiment includes a generator which is driven by an engine and has a plurality of power generation windings wound around the generator. The engine-driven welding machine has the function of rectifying AC power generated by each of the power generation windings and outputting the rectified DC power from a corresponding welding output terminal. Specifically, the engine-driven welding machine of this embodiment includes a plurality of DC power supplies, and has the function of integrating the outputs, i.e., collectively outputting the outputs of the plurality of DC power supplies from a predetermined welding output terminal. Further, the engine-driven welding machine has the function of individually outputting the outputs from the respective DC power supplies to the individual welding output terminals. As one of its features, the engine-driven welding machine can perform automatic switching between an output integration setting in which the outputs are integrated and an individual output setting in which the outputs are individually outputted in accordance with a value set at an output regulating dial serving as a current selector to be described later.

A detailed description will be given below.

### <Configuration of Engine-Driven Welding Machine>

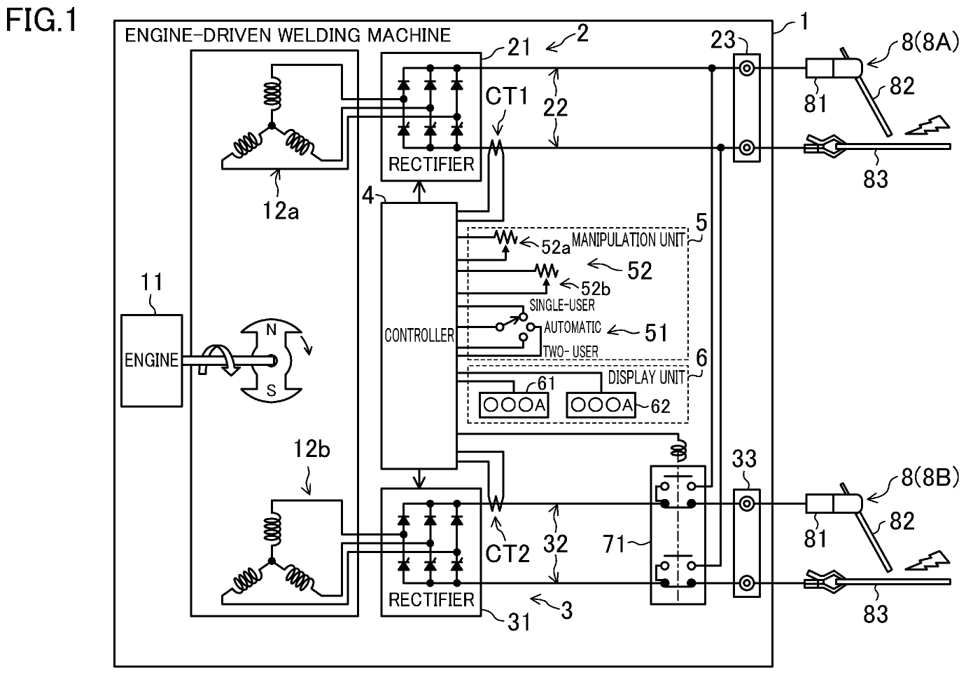

FIG. 1 is a schematic diagram illustrating a configuration of an engine-driven welding machine 1 of this embodiment.

The engine-driven welding machine 1 includes a plurality of DC power supplies 2, 3 and a controller 4 having the function of controlling the operation of the engine-driven welding machine 1. To facilitate the understanding of the invention, FIG. 1 illustrates an example in which two DC power supplies 2, 3 are provided. For the sake of convenience of description, one of the DC power supplies shown on the upper side of the drawing will be referred to as a first DC power supply 2, and the other on the lower side in the drawing will be referred to as a second DC power supply 3.

The first DC power supply 2 is configured to rectify, with a first rectifier 21, AC power generated by a first power generation winding 12a of a generator driven by an engine 11, and to output the rectified DC power from a first welding output terminal 23 via a first distribution line 22.

The second DC power supply 3 is configured to rectify, with a second rectifier 31 serving as an output circuit, AC power generated by a second power generation winding 12b of the generator driven by the engine 11, and to output the rectified DC power from a second welding output terminal 33 via a second distribution line 32.

A first CT sensor CT1 for measuring an output current of the first DC power supply 2 is attached to the first power distribution line 22. The measurement result of the first CT sensor CT1 is sent to the controller 4.

The second distribution line 32 is provided with a switching relay 71 (corresponding to an output switcher) which performs, under the control of the controller 4, switching between connection of the output of the second DC power supply 3 to the second welding output terminal 33 and connection of the output of the second DC power supply 3 to the first welding output terminal 23. A second CT sensor CT2 serving as a current measurer which measures an output current of the second DC power supply 3 is attached to the second power distribution line 32. The measurement result of the second CT sensor CT2 is sent to the controller 4.

The engine-driven welding machine 1 is provided with a manipulation unit 5 which is manipulated by a user, and a display unit 6 which displays a value of the output current of each of the first and second DC power supplies 2, 3.

The manipulation unit 5 includes a mode selector switch 51, and an output regulating dial 52 serving as a current selector.

The mode selector switch 51 is a switch for selecting (switching) an output mode to be applied among a “single-user mode” suitable for an operation by a single user, a “two-user mode” suitable for an operation by two users, and an “automatic switching mode.”

In the “single-user mode,” which is a first output mode, the outputs of the first and second DC power supplies 2, 3 are collectively outputted from the first welding output terminal 23 serving as a predetermined welding output terminal, and the switching relay 71 is switched for the connection to the first DC power supply 2 (switched to the upper side (indicated by open circles) in FIG. 1).

In the “two-user mode,” which is a second output mode, the outputs from the first and second DC power supplies 2, 3 are individually outputted to the welding output terminals 23, 33, respectively, and the switching relay 71 is switched for the connection to the second DC power supply 3 (the lower side (indicated by solid circles) in FIG. 1).

In the “automatic switching mode,” switching between the “single-user mode” and the “two-user mode” is automatically performed. The specific manner of switching will be described in detail later.

In the “single-user mode,” the output of the first DC power supply 2 and the output of the second DC power supply 3 may be collectively outputted from the second welding output terminal 33. This configuration also provides the same advantages.

The output regulating dial 52 includes a dial-shaped first output regulating dial 52a and a dial-shaped second output regulating dial 52b. The first and second output regulating dials 52a and 52b are turned in order to regulate the outputs of the first and second DC power supplies, respectively, in the “two-user mode.” In the “single-user mode,” the total value of the outputs of the first and second DC power supplies 2, 3 can be regulated via the first output regulating dial 52a.

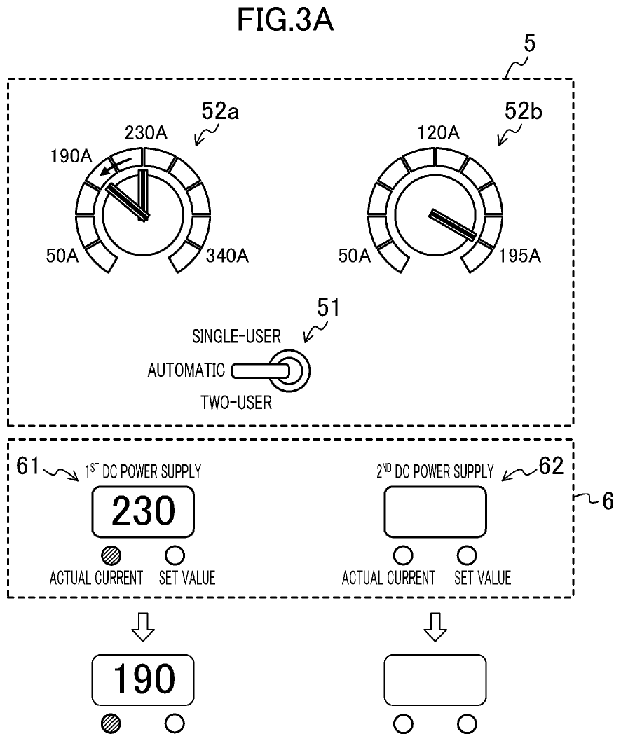

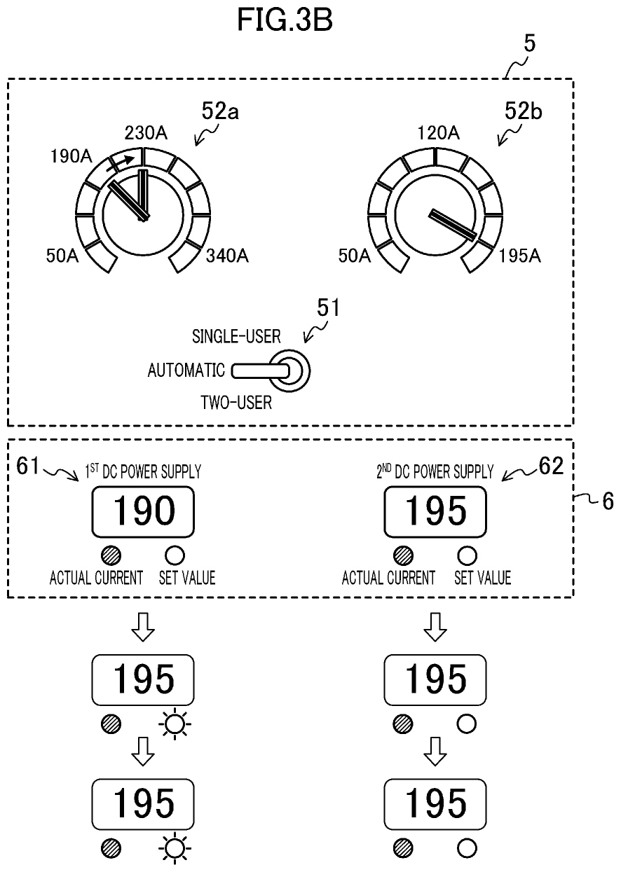

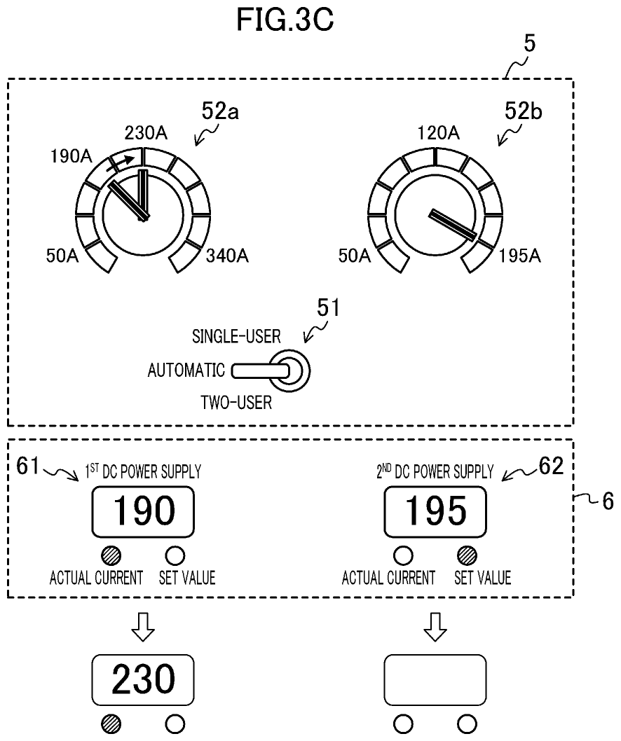

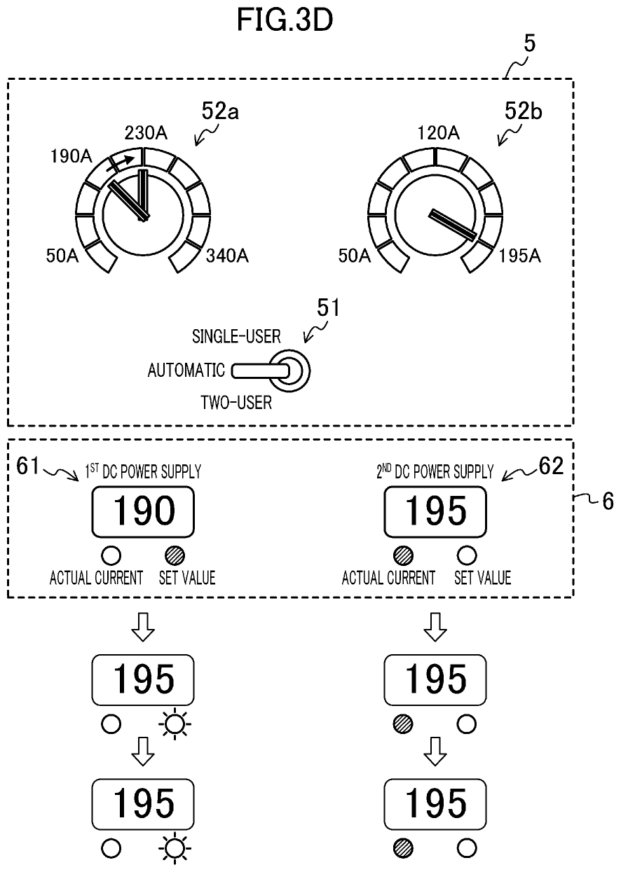

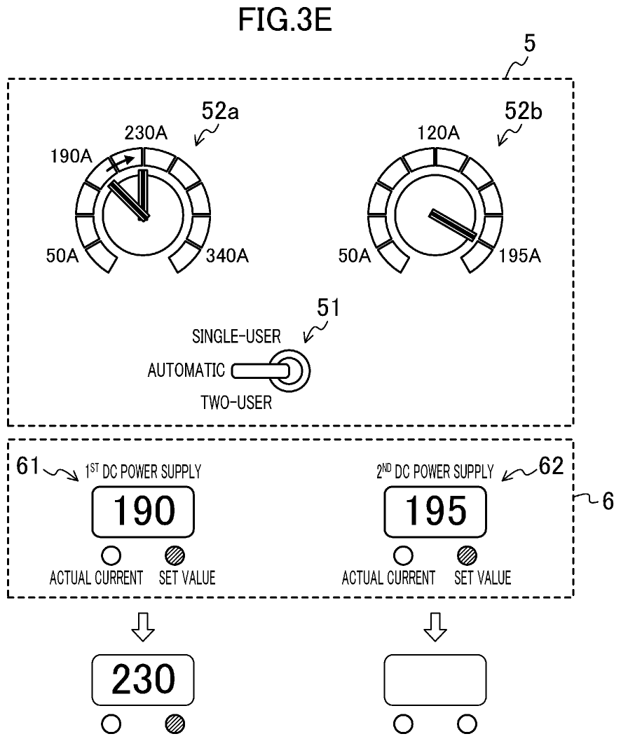

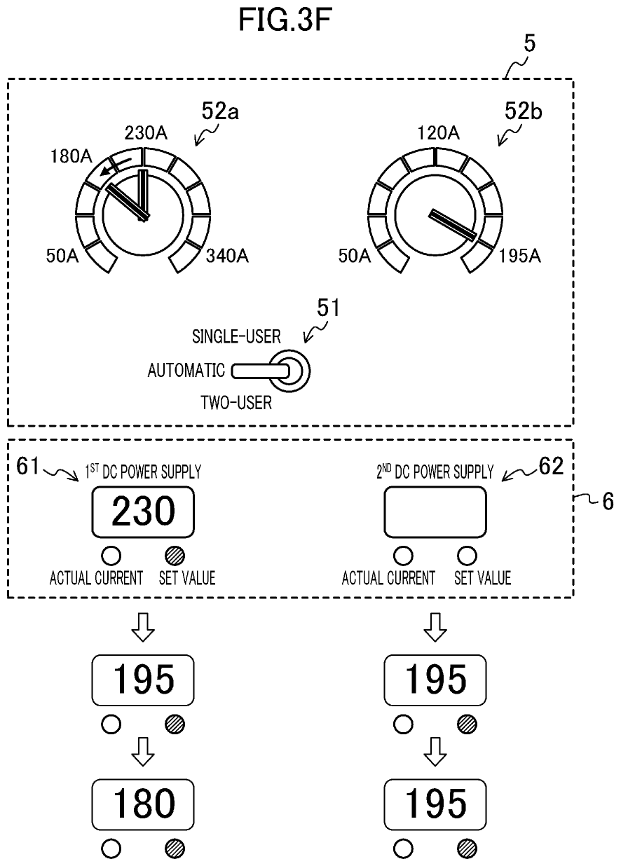

The display unit 6 includes a first display 61 for displaying a value of the output current of the first DC power supply 2, and a second display 62 for displaying a value of the output current of the second DC power supply 3. Each of the first and second displays 61, 62 is able to display a value set via the output regulating dial 52 of the manipulation unit 5, and a current (indicated as an “actual current” in FIG. 3) measured by an associated one of the first and second CT sensors CT1 and CT2. In this specification, “CT1” and “CT2” are used as reference characters representing both the CT sensors themselves and the values measured by the CT sensors.

For example, as shown in FIGS. 3A to 3F, each of the first and second displays 61, 62 includes a seven-segment display screen on which the value of the output current is displayed, and light emitting portions indicating whether the numeric value displayed on the display screen is the “set value” or the “actual current.” In the following description, the light emitting portion indicating the “set value” will be referred to as a set value lamp, and the light emitting portion indicating the “actual current” will be referred to as an actual current lamp.

More specifically, in the “single-user mode,” the display unit 6 displays the total value CT0 (CT1+CT2) of the output currents of the first and second DC power supplies 2 and 3 on the first display 61. In the “two-user mode,” the display unit 6 displays the measured value CT1 of the output current of the first DC power supply 2 on the first display 61, and the measured value CT2 of the output current of the second DC power supply 3 on the second display 62.

When a current is flowing to the welding output terminal 23, 33, the actual current lamp of the corresponding display 61, 62 is turned on, and the value of the current measured by the corresponding CT sensor CT1, CT2 is preferentially displayed. When no current flows to the welding output terminal 23, 33, the set value lamp of the display 61, 62 is turned on, and the value set via the output regulating dial 52 is displayed. The display of the “actual current” and the “set value” is not limited thereto, and may be implemented in a different manner. For example, the “actual current” and the “set value” may be alternately displayed when a current is flowing.

The engine-driven welding machine 1 includes a control board (not shown), on which a microcontroller or any other components having the function of the controller 4 is mounted.

The controller 4 reads the setting of the mode selector switch 51 and the value set via the output regulating dial 52, and controls the switching relay 71 in accordance with the setting and the value. Further, the controller 4 controls what is displayed on the first display 61 based on the current value measured by the first CT sensor CT1. Likewise, the controller 4 controls what is displayed on the second display 62 based on the current value measured by the second CT sensor CT2. The specific operation of the controller 4 will be described in detail in the following section of “Operation of Engine-Driven Welding Machine.”

### <Operation of Engine-Driven Welding Machine>

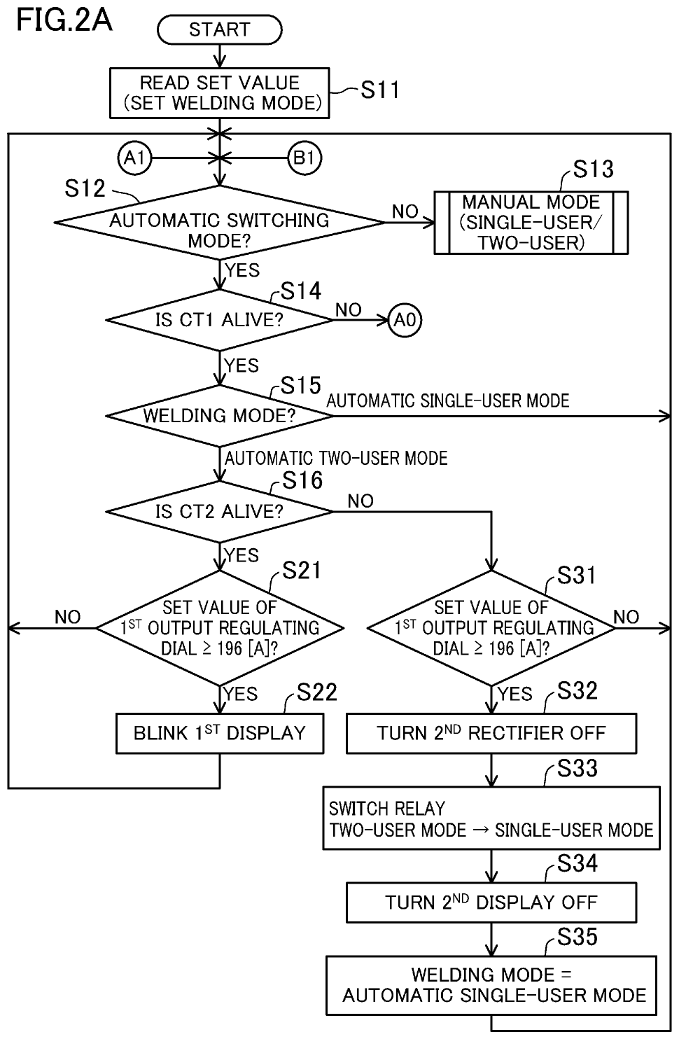

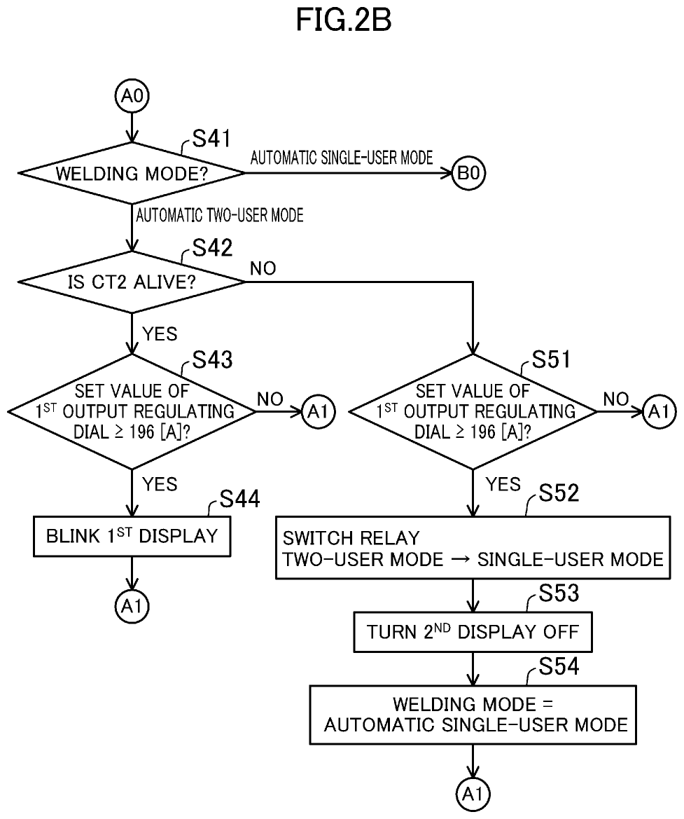

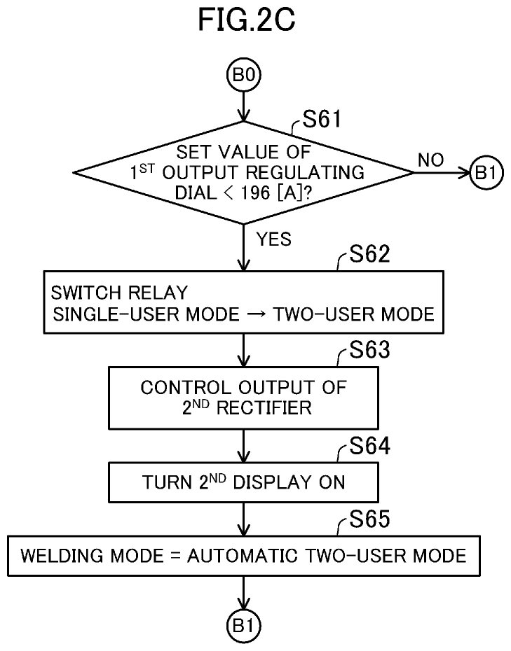

The operation and control performed by the engine-driven welding machine 1 will be described in detail with reference to FIGS. 1 and 2. FIG. 2 is a flowchart illustrating an example of the operation of the engine-driven welding machine 1. Unless otherwise specified, it is assumed that the operation of the engine-driven welding machine 1 is principally controlled by the controller 4.

In the following description, as shown in FIG. 1, a welding apparatus 8 is connected to each of the first and second DC power supplies 2, 3. Specifically, for each of the DC power supplies 2, 3, a welding torch 81 is connected to a positive electrode of the welding output terminal 23, 33, and an iron plate 83 to be welded is connected to a negative electrode of the welding output terminal 23, 33. A welding rod 82 is attached to the tip end of the welding torch 81. In this embodiment, an appliance related to the welding operation including the welding torch 81, the welding rod 82, and the iron plate 83 is collectively referred to as the welding apparatus 8. The welding apparatus 8 connected to the first welding output terminal 23 will be referred to as a first welding apparatus 8A, and the welding apparatus 8 connected to the second welding output terminal 33 will be referred to as a second welding apparatus 8B.

In Steps S21, S31, S43, S51, and S61 described later, it is determined whether the value set via the first output regulating dial 52a is equal to or greater than a predetermined reference value or less than the predetermined reference value. In the following description, it is assumed that the predetermined reference value is 196 A. The predetermined reference value can be optionally set in accordance with the output capacity or any other capability of the engine-driven welding machine 1. For example, the predetermined reference value is set based on a maximum current value that can be outputted from the DC power supplies 2, 3. Specifically, the predetermined reference value is set to be the maximum current value that the first and second DC power supplies 2, 3 can individually supply to the welding output terminals 23, 33. In the following description, for the sake of convenience of description, it is assumed that both of the maximum current values that can be supplied by the first and second DC power supplies 2, 3 are 195 A. Note that the maximum current values do not have to be 195 A, and the first and second DC power supplies 2, 3 may supply different maximum current values. Such a configuration allows the engine-driven welding machine to be operated in the same manner as will be described below, and provides the same advantages.

First, in Step S11 shown in FIG. 2A, the controller 4 reads setting of the mode selector switch 51 and a value set via the first output regulating dial 52a. Then, an initial value for the “welding mode” is set in accordance with the set value of the first output regulating dial 52a. The “welding mode” includes an “automatic single-user mode” and an “automatic two-user mode.”

The “automatic single-user mode” refers to a mode as follows. In a situation where the mode selector switch 51 has been set to the “automatic switching mode,” selection of the “automatic single-user mode” causes the switching relay 71 to be set in the “single-user mode” described above. For example, when the set value of the first output regulating dial 52a is equal to or greater than 196 A, the controller 4 sets the initial value of the “welding mode” to be the “automatic single-user mode.”

The “automatic two-user mode” refers to a mode as follows. In a situation where the mode selector switch 51 has been set to the “automatic switching mode,” selection of the “automatic two-user mode” causes the switching relay 71 to be set in the “two-user mode” described above. For example, if the set value of the first output regulating dial 52a is less than 196 A, the controller 4 sets the initial value of the “welding mode” to be the “automatic two-user mode.”

The initial value of the “welding mode” may be suitably set not later than timing when the “welding mode” is determined in Step S15 to be described later.

In Step S12, the controller 4 determines whether the mode selector switch 51 is in the “automatic switching mode” (indicated as “automatic” in FIGS. 3A to 3F). If the mode selector switch 51 is in a “manual single-user mode” (indicated as “single-user” in FIGS. 3A to 3F) or a “manual two-user mode” (indicated as “two-user” in FIGS. 3A to 3F), the process proceeds to Step S13.

In Step S13, the controller 4 fixes the output mode of the engine-driven welding machine 1 to the one corresponding to the setting of the mode selector switch 51. For example, if the mode selector switch 51 is in the “manual single-user mode” (corresponding to a first output fixing mode), the controller 4 sets (fixes) the switching relay 71 to the “single-user mode.” In this manner, the engine-driven welding machine 1 collectively outputs the output currents of the first and second DC power supplies 2 and 3 from the first welding output terminal 23. If the mode selector switch 51 is in the “manual two-user mode” (corresponding to a second output fixing mode), the controller 4 sets (fixes) the switching relay 71 to the “two-user mode.” In this manner, the engine-driven welding machine 1 outputs the output current of the first DC power supply 2 from the first welding output terminal 23, and outputs the output current of the second DC power supply 3 from the second welding output terminal 33.

If the mode selector switch 51 is in the automatic switching mode in Step S12, the process proceeds to Step S14. Various exemplary cases of the operation in Step S14 and the subsequent steps will be described in detail below.

### First Operation Example

This operation example is based on the assumption shown in FIG. 3A: it is assumed that the mode selector switch 51 is in the “automatic switching mode,” and in the initial state, the set value of the first output regulating dial 52a is 230 A, and the set value of the second output regulating dial 52b is 195 A. That is, it is assumed that the initial value of the “welding mode” is the “automatic single-user mode.” In the “automatic single-user mode,” the second display 62 is in a non-display state, i.e., is turned off.

It is also assumed that the first welding apparatus 8A is in operation while receiving a current, whereas the second welding apparatus 8B is not in operation while receiving no current.

In Step S14, based on a measured value of the first CT sensor CT1, it is determined whether the output current of the first DC power supply 2 is supplied. In this example, the current is flowing through the first distribution line 22. Thus, the answer in Step S14 is “YES.”

In Step S15, it is determined whether the “welding mode” is set to be the “automatic single-user mode” or the “automatic two-user mode.” In this example, the initial value of the “welding mode” is the “automatic single-user mode.” Thus, the process returns to Step S12.

While the current is continuously flowing through the first distribution line 22, i.e., while the first welding apparatus 8A is in operation, Steps S12 to S15 are repeated. That is, even if the set value of the first output regulating dial 52a becomes equal to or less than 195 A (e.g., 190 A), the “automatic single-user mode” continues, and the switching relay 71 remains in the “single-user mode.” This can reduce the frequent switching of the relay.

### Second Operation Example

This operation example is based on the assumption shown in FIG. 3B: it is assumed that the mode selector switch 51 is in the “automatic switching mode,” and in the initial state, the set value of the first output regulating dial 52a is 190 A, and the set value of the second output regulating dial 52b is 195 A. That is, it is assumed that the initial value of the “welding mode” is the “automatic two-user mode.”

It is also assumed that both of the first and second welding apparatuses 8A and 8B are in operation, i.e., are receiving currents. Further, it is assumed that the set value of the first output regulating dial 52a is changed from 190 A to 230 A when a predetermined time has passed.

In this operation example, the current is flowing through the first distribution line 22. Thus, the answer in Step S14 is “YES.” Further, since the initial value of the “welding mode” is the “automatic two-user mode,” the process proceeds from Step S15 to Step S16.

In Step S16, based on a measured value of the second CT sensor CT2, the controller 4 determines whether the output current of the second DC power supply 3 is supplied. In this example, the current is flowing through the second distribution line 32. Thus, the answer is “YES,” and the process proceeds to Step S21.

In Step S21, it is determined whether the set value of the first output regulating dial 52a is at least 196 A. Since the set value of the first output regulating dial 52a is 190 A when the predetermined time has not yet passed, the answer in Step S21 is “NO,” and the process returns to Step S12.

When the predetermined time has passed, the set value of the first output regulating dial 52a becomes equal to or greater than 196 A. Thus, the answer in Step S21 is “YES,” and the process proceeds to Step S22.

In this operation example, the current is supplied to the second welding apparatus 8B. Thus, even if the set value of the first output regulating dial 52a becomes equal to or greater than 196 A, a current exceeding 195 A cannot be supplied to the first welding apparatus 8A. In the subsequent Step S22, the controller 4 causes the first display 61 to keep showing the numeric value “195 A,” to keep lighting the actual current lamp, and to blink the set value lamp (see part of FIG. 3B below the arrows). At this time, the second display 62 is kept unchanged.

This can keep the switching relay 71 from being switched during the operation of the welding apparatus 8B connected to the second DC power supply 3, and can reduce adverse influence on the operation. Further, this can substantially avoid a situation where excessive stress applied to the switching relay 71 causes failure of the switching relay 71, and can protect the engine-driven welding machine 1 itself from failure. Further, the user can be informed that the current equal to the set value of the first output regulating dial 52a is not outputted because the welding apparatus 8B is in operation.

When Step S22 is finished, the process returns to Step S12.

### Third Operation Example

This operation example is based on the assumption shown in FIG. 3C: it is assumed that the mode selector switch 51 is in the “automatic switching mode,” and in the initial state, the set value of the first output regulating dial 52a is 190 A, and the set value of the second output regulating dial 52b is 195 A. That is, it is assumed that the initial value of the “welding mode” is the “automatic two-user mode.”

It is also assumed that the first welding apparatus 8A is in operation while receiving a current, whereas the second welding apparatus 8B is not in operation while receiving no current. Further, it is assumed that the set value of the first output regulating dial 52a is changed from 190 A to 230 A when a predetermined time has passed.

Since Steps S14 and S15 are the same as those of the above-described “Second Operation Example,” they are not described below, and the operations in Step S16 and subsequent steps will be described.

In this operation example, no current flows through the second distribution line 32. Thus, the answer in Step S16 is “NO,” and the process proceeds to Step S31.

In Step S31, it is determined whether the set value of the first output regulating dial 52a is at least 196 A. Since the set value of the first output regulating dial 52a is 190 A when the predetermined time has not yet passed, the answer is “NO” in Step S31, and the process returns to Step S12.

When the predetermined time has passed, the set value of the first output regulating dial 52a becomes equal to or greater than 196 A, and the answer in Step S31 is “YES.” Thus, the process proceeds to Step S32.

In this operation example, no current is supplied to the second welding apparatus 8B. Therefore, the controller 4 turns the second rectifier 31 off (Step S32), sets the switching relay 71 to the “single-user mode” (Step S33), turns the second display 62 off (Step S34), and sets the “welding mode” to the “automatic single-user mode” (Step S35). Then, the process returns to Step S12.

### Fourth Operation Example

This operation example is based on the assumption shown in FIG. 3D: it is assumed that the mode selector switch 51 is in the “automatic switching mode,” and in the initial state, the set value of the first output regulating dial 52a is 190 A, and the set value of the second output regulating dial 52b is 195 A. That is, it is assumed that the initial value of the “welding mode” is the “automatic two-user mode.”

It is also assumed that the first welding apparatus 8A is not in operation while receiving no current, whereas the second welding apparatus 8B is in operation while receiving the current. Further, it is assumed that the set value of the first output regulating dial 52a is changed from 190 A to 230 A when a predetermined time has passed.

In this operation example, no current flows through the first distribution line 22. Thus, the answer is “NO” in Step S14, and the process proceeds to Step S41 shown in FIG. 2B.

In Step S41, it is determined whether the “welding mode” is the “automatic single-user mode” or the “automatic two-user mode.” Since the initial value of the “welding mode” is the “automatic two-user mode,” the process proceeds to Step S42.

In Step S42, based on a measured value of the second CT sensor CT2, the controller 4 determines whether the output current of the second DC power supply 3 is supplied. Since the current is flowing through the second distribution line 32, the answer is “YES,” and the process proceeds to Step S43.

In Step S43, it is determined whether the set value of the first output regulating dial 52a is at least 196 A. Since the set value of the first output regulating dial 52a is 190 A when the predetermined time has not yet passed, the answer is “NO” in Step S43, and the process returns to Step S12 shown in FIG. 2A.

Once the predetermined time has passed, the set value of the first output regulating dial 52a becomes equal to or greater than 196 A. Thus, the answer is “YES” in Step S43, and the process proceeds to Step S44.

In this operation example, the current is supplied to the second welding apparatus 8B. Thus, even if the set value of the first output regulating dial 52a becomes equal to or greater than 196 A, a current exceeding 195 A cannot be supplied to the first welding apparatus 8A. In the subsequent Step S44, the controller 4 causes the first display 61 to keep showing the numeric value “195 A,” and to blink the set value lamp.

This can keep the switching relay 71 from being switched during the operation of the welding apparatus 8B connected to the second DC power supply 3, and can adverse influence on the operation. Further, this can protect the switching relay 71 and the engine-driven welding machine 1 themselves from failure. In addition, the user can be informed that the current equal to the set value of the first output regulating dial 52a is not outputted. When Step S44 is finished, the process returns to Step S12 in FIG. 2A.

### Fifth Operation Example

This operation example is based on the assumption shown in FIG. 3E: it is assumed that the mode selector switch 51 is in the “automatic switching mode,” and in the initial state, the set value of the first output regulating dial 52a is 190 A, and the set value of the second output regulating dial 52b is 195 A. That is, it is assumed that the initial value of the “welding mode” is the “automatic two-user mode.”

It is also assumed that both of the first and second welding apparatuses 8A and 8B are not in operation, i.e., are receiving no current. Further, it is assumed that the set value of the first output regulating dial 52a is changed from 190 A to 230 A when a predetermined time has passed.

Since Steps S14 and S41 are the same as those of the above-described “Fourth Operation Example,” they are not described below, and the operations in Step S42 and subsequent steps will be described.

In this operation example, no current flows through the second distribution line 32. Thus, the answer is “NO” in Step S42, and the process proceeds to Step S51.

In Step S51, it is determined whether the set value of the first output regulating dial 52a is at least 196 A. Since the set value of the first output regulating dial 52a is 190 A when a predetermined time has not yet passed, the answer is “NO” in Step S51, and the process returns to Step S12 shown in FIG. 2A.

When the predetermined time has passed, the set value of the first output regulating dial 52a becomes equal to or greater than 196 A. Thus, the answer is “YES” in Step S51, and the process proceeds to Step S52.

In this operation example, no current is supplied to the second welding apparatus 8B. Therefore, the controller 4 sets the switching relay 71 to the “single-user mode” (Step S52), turns the second display 62 off (Step S53), and sets the “welding mode” to the “automatic single-user mode” (Step S54). Then, the process returns to Step S12 shown in FIG. 2A.

### Sixth Operation Example

This operation example is based on the assumption shown in FIG. 3F: it is assumed that the mode selector switch 51 is in the “automatic switching mode,” and in the initial state, the set value of the first output regulating dial 52a is 230 A, and the set value of the second output regulating dial 52b is 195 A. That is, it is assumed that the initial value of the “welding mode” is the “automatic single-user mode.”

It is also assumed that both of the first and second welding apparatuses 8A and 8B are not in operation, i.e., are receiving no current. Further, it is assumed that the set value of the first output regulating dial 52a is changed from 230 A to 180 A when a predetermined time has passed.

In this operation example, no current flows through the first distribution line 22. Thus, the answer is “NO” in Step S14, and the process proceeds to Step S41 shown in FIG. 2B. Since the initial value of the “welding mode” is the “automatic single-user mode,” the process proceeds from Step S41 to Step S61 shown in FIG. 2C.

In Step S61, it is determined whether the set value of the first output regulating dial 52a is less than 196 A. Since the set value of the first output regulating dial 52a is 230 A when the predetermined time has not yet passed, the answer is “NO” in Step S61, and the process returns to Step S12 shown in FIG. 2A.

Once the predetermined time has passed, the set value of the first output regulating dial 52a becomes less than 196 A. Thus, the answer is “YES” in Step S61, and the process proceeds to Step S62.

In this operation example, no current is supplied to the first and second welding apparatuses 8A and 8B. Then, the controller 4 sets the switching relay 71 to the “two-user mode” (Step S62).

In the subsequent Step S63, the controller 4 controls the output of the second rectifier 31. Specifically, the control 4 reduces the voltage applied to the second welding output terminal 33. For example, the voltage applied to the second welding output terminal 33 is reduced from 70 V to 25 V or less, which is a permissible contact voltage. Further, simultaneously with the setting of the switching relay 71 to the “two-user mode,” the controller 4 performs control such that the output current of the second DC power supply 3 is reduced to be less than a predetermined value in response to detection of the current by the second CT sensor CT2, regardless of the set value of the second output regulating dial 52b. This can reduce or prevent generation of an arc. When it is observed that the current has been interrupted for a predetermined time or longer after the reduction of the output current of the second DC power supply 3 to be less than the predetermined value, the output current of the second DC power supply 3 is resumed. Thus, an automatic resume function can be implemented while safety is secured.

Then, the controller 4 causes the second display 62 to display the value of the output current (Step S64), and sets the “welding mode” to the “automatic two-user mode” (Step S65), and the process returns to Step S12 shown in FIG. 2A. Thus, the user can be informed that the output current can be supplied to the welding apparatus 8B connected to the second welding output terminal 33.

As described above, according to this embodiment, the controller 4 reads the set value of the output regulating dial 52, and controls the switching relay 71 according to the set value so that the switching between the first output mode and the second output mode is performed. That is, the switching from the “single-user mode” to the “two-user mode,” and the switching from the “two-user mode” to the “single-user mode” are automatically performed without need of the user's manipulation of the mode selector switch 51. Since the switching relay 71 is switched when the current is not supplied from the second DC power supply 3, no excessive stress is applied to the switching relay 71.

In the above embodiment (e.g., Steps S33 and S52), how to switch the switching relay from the “two-user mode” to the “single-user mode” is not particularly limited. Two examples of the switching will be described below.

As a first example, the second rectifier 31 is actuated to start the output of the second DC power supply 3 when a predetermined time (e.g., 0.5 seconds) has passed from the switching of the switching relay 71 upon detection that the set value of the first output regulating dial 52a has become equal to or greater than a predetermined reference value (e.g., 196 A or more). For example, when contact points of the switching relay 71 are made of electromagnetic coils, time (e.g., about 0.2 seconds) is required from the start of the operation until the contact points are connected. Thus, the second rectifier 31 is actuated when the time has passed, so that unnecessary stress is not applied to the contact points of the switching relay 71.

As a second example, the second rectifier 31 is actuated to start the output of the second DC power supply 3 immediately after the switching of the switching relay 71 upon detection that the set value of the first output regulating dial 52a has become equal to or greater than a predetermined reference value (e.g., 196 A or more). This can continuously increase the current.

While the preferred embodiment of the present invention and variations thereof have been described above, the technology according to the present disclosure is not limited thereto, but is also applicable to other embodiments which are altered or substituted as needed. Optionally, the components described in the above embodiment may be combined to create a new embodiment.

### Other Embodiments

For example, it has been described in the above embodiment that the first CT sensor CT1 is provided for the first power distribution line. However, the first CT sensor CT1 may be omitted. Such a configuration can also provide the same advantages as those of the above embodiment.

Further, in the above embodiment, a configuration with two DC power supplies has been described, but the present invention is not limited thereto. Specifically, the technology according to the present disclosure is also applicable to a configuration with three or more DC power supplies, and such a configuration can provide the same advantages as those described above.

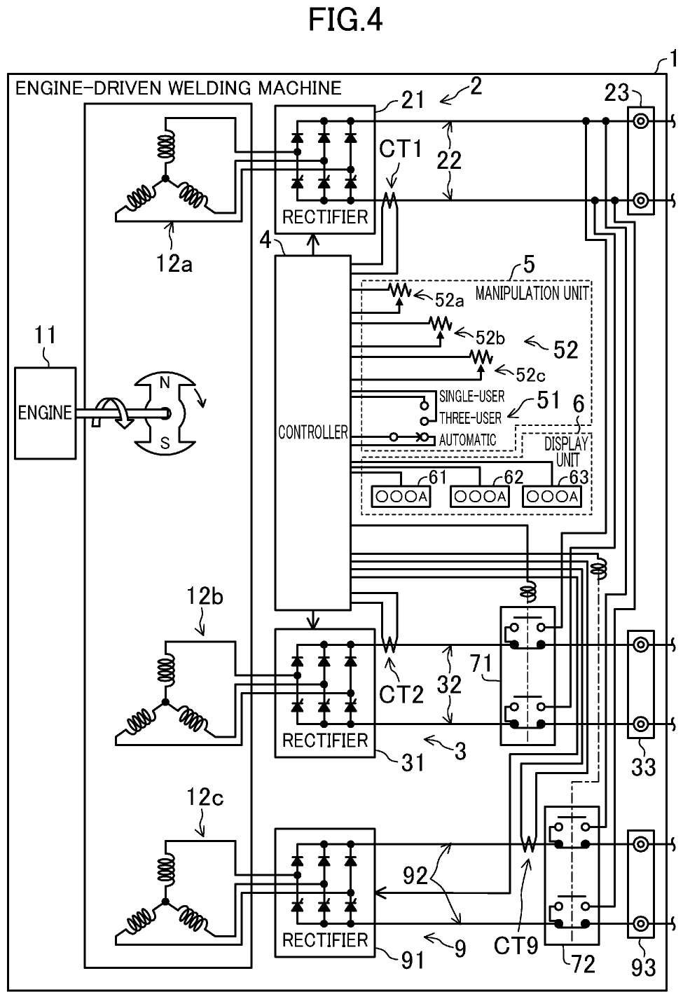

FIG. 4 shows a configuration example of the engine-driven welding machine 1 having three DC power supplies.

In the example of FIG. 4, a third DC power supply 9 is added in the lowermost part of the drawing. Specifically, the third DC power supply 9 is configured to rectify, with a third rectifier 91, AC power generated by a third power generation winding 12c of a generator driven by an engine 11, and to output the rectified DC power from a third welding output terminal 93 via a single-phase third power distribution line 92.

A third display unit 63 for displaying a value of the output current of the third DC power supply 9 is added to the display unit 6, and a dial-shaped third output regulating dial 52c for regulating the output of the third DC power supply 9 is added to the manipulation unit 5.

A third distribution line 92 is provided with a switching relay 72 which performs, under the control of a controller 4, switching between connection of the output of the third DC power supply 9 to the third welding output terminal 93 and connection of the output of the third DC power supply 9 to the first welding output terminal 23. Further, a third CT sensor CT9 serving as a current measurer for measuring an output current of the third DC power supply 9 is attached to the third power distribution line 92. The measurement result of the third CT sensor CT 9 is sent to the controller 4.

In the configuration of FIG. 4, the operation of the engine-driven welding machine 1 is similar to that described in the above embodiment, and a detailed description thereof will be omitted herein. Specifically, the switching relay 72 provided for the third distribution line 92 may be controlled in the same manner as the switching relay 71 provided for the second distribution line 32 as described in the above embodiment. For example, in a case where the outputs of the first to third DC power supplies 2, 3, 9 are collectively outputted from the first welding output terminal 23 serving as a predetermined welding output terminal, i.e., in the case of the “single-user mode” as the first output mode, the switching relay 71 and the switching relay 72 are switched for the connection to the first DC power supply 2 (switched to the upper side (indicated by open circles) in FIG. 4). On the other hand, in a case where the outputs from the first to third DC power supplies 2, 3, 9 are respectively outputted from the individual welding output terminals 23, 33, 93, i.e., in the case of a “three-user mode” as the second output mode, the switching relay 71 is switched for the connection to the second DC power supply 3 (to the lower side (indicated by solid circles) in FIG. 4), and the switching relay 72 is switched for the connection to the third DC power supply 9 (to the lower side (indicated by solid circles) in FIG. 4).

In the above embodiment, the first and second displays 61, 62 respectively have the display screens for displaying the value of the output current, but the present invention is not limited thereto. For example, each of the first and second displays 61, 62 may be an analog display which indicates a current value by means of a pointer. In this case, in Steps S34 and S53, the controller 4 causes the pointer of the second display 62 to point 0 A regardless of the current actually measured by the second CT sensor CT2, thereby causing the second display 62 to display a numeric value “zero” corresponding to the turn-off state described above. In the “two-user mode,” the controller 4 causes the first and second displays 61, 62 to be in the display state, i.e., to display the values of the output currents.

### INDUSTRIAL APPLICABILITY

The present invention is significantly useful because the output mode can be automatically switched in accordance with the output current set via the current selector.

### DESCRIPTION OF REFERENCE CHARACTERS

1 Engine-Driven Welding Machine
2 First DC Power Supply (DC Power Supply)
3 Second DC Power Supply (DC Power Supply)
4 Controller
6 Display Unit (Display)
23 First Welding Output Terminal (Welding Output Terminal, First Output Terminal)
33 Second Welding Output Terminal (Welding Output Terminal)
51 Mode Selector Switch
52 Output Regulating Dial (Current Selector)
71 Switching Relay (Output Switcher)

1. An engine-driven welding machine having a plurality of DC power supplies and a plurality of welding output terminals respectively corresponding to the DC power supplies, the engine-driven welding machine comprising:
a current selector via which a user sets a current for each of the DC power supplies, and which outputs a setting signal based on the current set by the user;
an output switcher which performs switching between a first output mode in which outputs of the DC power supplies are collectively outputted from a first output terminal which is a predetermined welding output terminal of the welding output terminals, and a second output mode in which outputs of the DC power supplies are each outputted individually from an associated one of the welding output terminals; and
a controller which controls, upon receiving the setting signal from the current selector, the output switcher in accordance with the setting signal, so that the output switcher automatically switches to the first output mode when a value of the set current is equal to or greater than a predetermined current value, or to the second output mode when the value of the set current is less than the predetermined current value.

2. The engine-driven welding machine of claim 1, further comprising:
a current measurer which measures an output current outputted from at least one of the plurality of welding output terminals, wherein
the controller controls the output switcher when it is determined that no output current is flowing.

3. The engine-driven welding machine of claim 2, wherein
the controller allows the output switcher to switch from the second output mode to the first output mode after stopping the output of the DC power supply, the output additionally supplying an output current to the first output terminal.

4. The engine-driven welding machine of claim 1, further comprising:
a current measurer which measures an output current outputted from at least the predetermined welding output terminal of the plurality of welding output terminals, wherein
in a situation where the engine-driven welding machine is in the first output mode, the controller maintains the first output mode when a current is flowing through the current measurer.

5. The engine-driven welding machine of claim 1, further comprising:
a mode selector switch via which the user selects any one of a first output fixing mode in which the engine-driven welding machine is fixed to the first output mode, a second output fixing mode in which the engine-driven welding machine is fixed to the second output mode, or an automatic switching mode, wherein
the controller automatically switches the output switcher when the automatic switching mode is selected via the mode selector switch.

6. The engine-driven welding machine of claim 1, further comprising:
a display which displays a value of each of the output currents of the plurality of welding output terminals, wherein
when switching to the first output mode, the controller causes the display corresponding to the other welding output terminals than the predetermined welding output terminal to be in a non-display state or to display zero.

7. The engine-driven welding machine of claim 6, wherein
when switching to the second output mode, the controller causes the display corresponding to all of the welding output terminals to be in a display state.
